(19) United States
(12) Patent Application Publication
(10) Pub. No.: US 2019/0203661 A1
(43) Pub. Date: Jul. 4, 2019

(54) SELECTIVE ABSORBER FOR HARVESTING SOLAR ENERGY

(71) Applicant: The Regents of the University of California, Oakland, CA (US)

(72) Inventors: Cristian Heredia, Davis, CA (US); Jerry Woodall, Davis, CA (US)

(73) Assignee: The Regents of the University of California, Oakland, CA (US)

(21) Appl. No.: 16/322,840

(22) PCT Filed: Aug. 22, 2017
(86) PCT No.: PCT/US2017/047948

§ 371 Date: Feb. 1, 2019

Related U.S. Application Data
(60) Provisional application No. 62/385,525, filed on Sep. 9, 2016.

(51) Int. Cl. F02G 1/055; F24S 23/30; F24S 70/225; F24S 60/10; F24S 23/74; F24S 70/10; F03G 6/06

(52) U.S. Cl. CPC F02G 1/055; F24S 23/30; F24S 70/225; F24S 60/10; F03G 2006/061; F24S 70/10; F03G 6/06; F02G 2254/30; F24S 23/74

(57) ABSTRACT

The disclosed embodiments relate to the design of a system that converts sunlight into electricity. During operation, the system concentrates the sunlight onto a front surface of a selective absorber, wherein the selective absorber comprises a semiconductor material having a band gap capable of absorbing most spectral components of the sunlight (such as intrinsic silicon), and wherein the concentrated sunlight causes heat to build up in the selective absorber. Next, the system uses heat obtained from the selective absorber to drive a heat engine, which converts the heat into mechanical energy. Finally, the system converts the mechanical energy into electricity.

### CROSS-REFERENCE TO RELATED APPLICATION

This application claims the benefit of U.S. Provisional Application Ser. No. 62/385,525, entitled “Characterizing Silicon at High Temperatures: A Selective Absorber for Solar Energy Harvesting,” by inventors Cristian Heredia and Jerry Woodall, Attorney Docket Number UC16-721-1PSP, filed on 9 Sep. 2016, the contents of which are incorporated by reference herein.

### BACKGROUND

### Field

The disclosed embodiments generally relate to systems for harvesting solar power. More specifically, the disclosed embodiments relate to a system that uses a selective absorber to collect thermal energy from sunlight, wherein the selective absorber has a high emissivity for shorter solar spectrum wavelengths and a low emissivity for longer infrared wavelengths.

### Related Art

Recent concerns about carbon emissions from fossil fuels have motivated researchers to develop new techniques for harvesting solar energy to meet the rising global demand for electricity. At present, most systems that generate electricity from sunlight use semiconductor-based photovoltaic cells to convert the sunlight directly into electricity.

Unfortunately, photovoltaic (PV) systems have a number of disadvantages. First, photovoltaic systems have a low energy-conversion efficiency, which presently averages about 20%. Second, PV systems are presently unable to store electricity, which means that after the sun goes down, the electrical grid must revert to using fossil fuels or nuclear plants to generate electricity.

In contrast to PV systems, “concentrated solar power” (CSP) systems use lenses or mirrors to focus sunlight into a concentrated beam, which is directed onto a heat-absorbing material to provide a heat source for a conventional power plant. Unlike smaller PV systems, which can be installed on individual rooftops, the larger scale of CSP systems makes it more practical for CSP systems to include mechanisms for storing thermal energy. By storing thermal energy, CSP systems can potentially provide electricity after the sun goes down.

However, CSP systems encounter efficiency losses while absorbing heat from concentrated sunlight. In a conventional CSP system, concentrated sunlight is typically focused on a blackbody absorber. However, a blackbody absorber suffers from being both a great absorber and great emitter at the same time. This means that blackbody absorbers lose efficiency as they re-radiate energy back into space.

Hence, what is needed is a CSP system that does not suffer from the above-described efficiency losses while absorbing heat from concentrated sunlight.

### SUMMARY

The disclosed embodiments relate to the design of a system that converts sunlight into electricity. During operation, the system concentrates the sunlight onto a front surface of a selective absorber, wherein the selective absorber comprises a semiconductor material having a band gap capable of absorbing most spectral components of the sunlight, and wherein the concentrated sunlight causes heat to build up in the selective absorber. Next, the system uses heat obtained from the selective absorber to drive a heat engine, which converts the heat into mechanical energy. Finally, the system converts the mechanical energy into electricity.

In some embodiments, the semiconductor material comprises intrinsic silicon.

In some embodiments, the system further comprises a heat-storage mechanism that uses a heat-storage medium to store heat obtained from the selective absorber, and subsequently uses the stored heat obtained from the heat-storage medium to drive the heat engine.

In some embodiments, the heat-storage medium comprises molten salt.

In some embodiments, the system further comprises a temperature regulator, which regulates a temperature of the selective absorber to remain in a normal-operating-temperature range between 500 and 600° C.

In some embodiments, the selective absorber: exhibits a first high emissivity for the shorter wavelength range associated with a solar blackbody spectrum; and exhibits a much lower second emissivity for a longer wavelength range associated with blackbody radiation emanating from the selective absorber while the selective absorber is in a normal-operating-temperature range.

In some embodiments, the front surface of the selective absorber includes a heat-reflecting layer, which reflects the incoming infrared radiation back into space, and reflects the infrared radiation from the selective absorber back onto the selective absorber, thereby lowering the total system emissivity for infrared wavelengths.

In some embodiments, the system uses one or more of the following mechanisms to concentrate the sunlight: a parabolic trough reflector; a solar tower system comprising an array of movable mirrors that focus the sunlight on a collector tower; a parabolic dish reflector, a circular Fresnel lens, and a linear Fresnel lens.

In some embodiments, the heat engine comprises a Stirling engine.

In some embodiments, the system uses an electric generator to convert the mechanical energy into electricity.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates an exemplary concentrated solar power (CSP) system in accordance with the disclosed embodiments.

FIG. 2 illustrates an exemplary CSP system that facilitates heat storage in accordance with the disclosed embodiments.

FIG. 3 presents a graph illustrating the spectral response for an ideal selective absorber in accordance with the disclosed embodiments.

FIG. 4 presents a graph illustrating how the solar blackbody spectrum relates to the energy band gap of silicon in accordance with the disclosed embodiments.

FIG. 5 presents a graph illustrating emissivity distributions for intrinsic silicon in temperature ranges from 100 to 700° C. in accordance with the disclosed embodiments.

FIG. 6 presents a flow chart illustrating the operations performed while converting sunlight into electricity in accordance with the disclosed embodiments.

FIG. 7 presents a graph illustrating spectral irradiance for intrinsic silicon heated to 500° C. in accordance with the disclosed embodiments.

Table 1 presents band gap energies for a number of well-studied semiconductors in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), flash drives and other portable drives, or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Concentrated Solar Power System

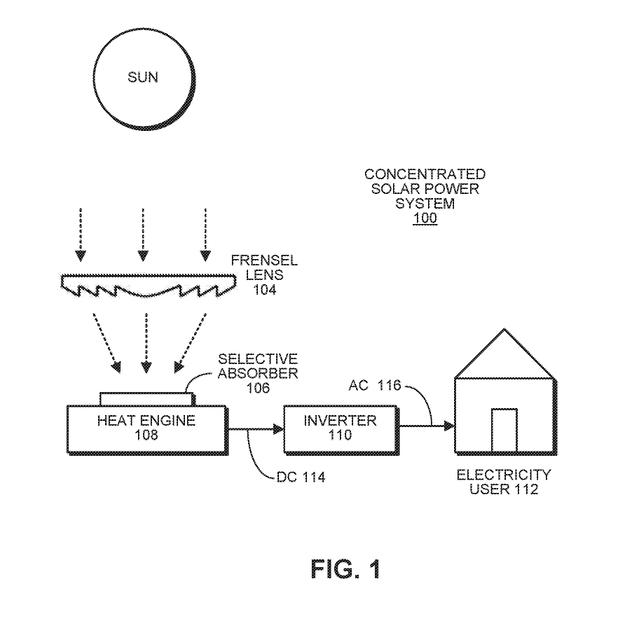

Before describing characteristics of a new type of selective absorber, we first describe a concentrated solar power (CSP) system that uses this new type of selective absorber to generate electricity from sunlight. More specifically, FIG. 1 illustrates an exemplary CSP system 100 in accordance with the disclosed embodiments. As illustrated in FIG. 1, CSP system 100 includes a number of components, including a Fresnel lens 104, a selective absorber 106, a heat engine 108 and an inverter 110. During operation, Fresnel lens 104 is used to concentrate sunlight onto a front surface of selective absorber 106. (Note that in general any type of refractive or reflective light concentrator, such as a lens or a mirror, can be used in place of Fresnel lens 104.) This concentrated light causes heat to build up in selective absorber 106.

Next, heat from selective absorber 106 is used to drive heat engine 108, which generates electricity as direct current (DC) 114. In general, any type of system that converts heat into electrical power can be used to implement heat engine 108. For example, a Stirling engine can be used to convert the heat into mechanical energy, and then an electric generator can be used to convert this mechanical energy into electricity.

Next, DC 114 is fed into an inverter, which converts DC 114 into alternating current (AC) 116. AC 116 is then transported through an electrical distribution network (not shown) to an electricity user 112.

CSP System with Heat Storage

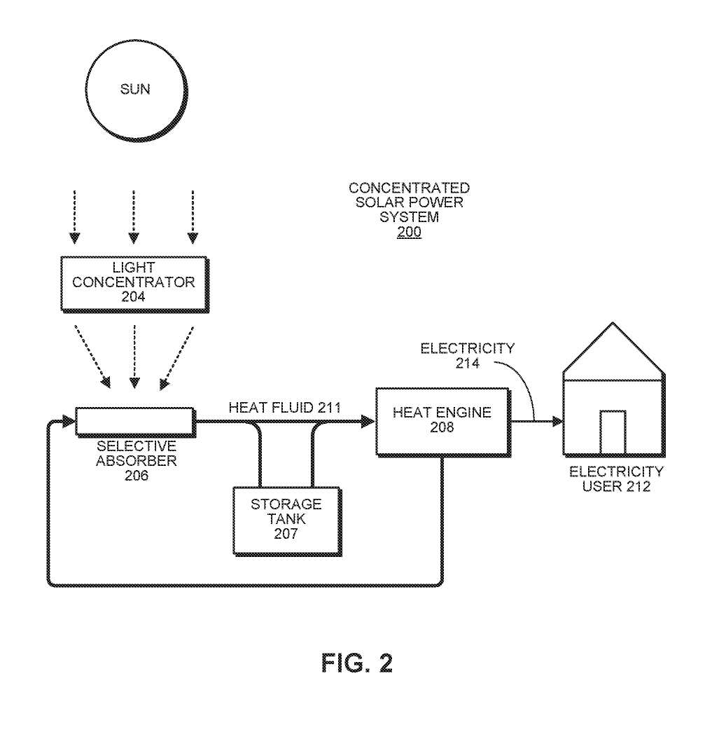

FIG. 2 illustrates an exemplary CSP system 200 that facilitates heat storage in accordance with the disclosed embodiments. As illustrated in FIG. 2, sunlight feeds through light concentrator 204, which concentrates the sunlight onto a front surface of selective absorber 206. This causes heat to build up in selective absorber 206. Next, this heat is transported using a heat fluid 211, such as molten salt, to a heat engine 208, which uses the heat to generate electricity 214. Electricity 214 is transported through an electrical distribution network (not shown) to an electricity user 212. Note that after heat fluid 211 passes through heat engine 208, it is returned to selective absorber 206 to repeat the process.

The heat fluid 211 from selective absorber 206 can also be directed into a storage tank 207, which can store the associated heat for use at a later time by heat engine 208 to generate electricity 214. In this way, CSP system 200 illustrated in FIG. 2 is able to provide electricity at times when the sun is not shining.

### Selective Absorbers

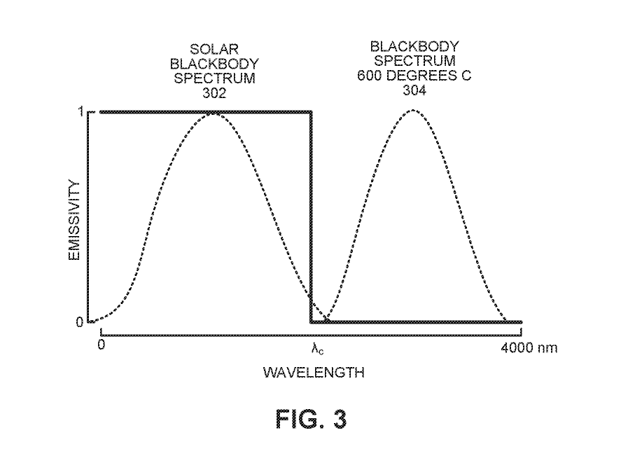

A number of different materials can be used to fabricate a selective absorber to collect thermal energy from sunlight. Note that unlike selective absorbers, the conventional absorbers used in existing CSP systems behave like blackbodies. Blackbodies absorb radiation over all wavelength ranges and will thus re-radiate over all wavelength ranges too. In contrast, by not re-radiating over certain wavelength ranges, selective absorbers more effectively convert solar energy into usable heat that does not get reradiated back into the environment. An ideal photothermal converter absorbs energy over the entire solar spectrum while minimizing re-radiative losses at longer wavelengths. For example, see FIG. 3, which presents a spectral response profile for an ideal selective absorber. This ideal selective absorber has an emissivity of 1.0 for shorter wavelengths associated with the solar blackbody spectrum 302, and an emissivity of 0.0 for longer wavelengths associated with a blackbody spectrum 304 for an operating temperature of 600° C. for the selective absorber. In this way, while the ideal selective absorber is operating at its normal operating temperature of 600° C., the ideal selective absorber will absorb heat from sunlight without re-radiating the heat through blackbody radiation at longer infrared wavelengths. Hence, an ideal selective absorber material for a CSP system possesses the following desirable properties: (1) spectral selectivity; (2) thermal conductivity; and (3) thermal stability.

Existing CSP systems use concentrated lenses to concentrate sunlight to get the temperature very high because conventional blackbody absorbers re-emit a lot of heat, which results in a low solar-power-in to electrical-power-out conversion efficiency. Note that a blackbody absorber rises to a temperature where the absorbed heat is re-radiated back out into space. In contrast, a selective absorber will absorb solar energy, get hot, and re-emit just a little bit of power. The rest of the power is either put to use in real-time or moved into storage. Hence, a new CSP system with a selective absorber does not have to concentrate sunlight as much as existing CSP systems because the selective absorber is more efficient than a conventional blackbody absorber at converting sunlight into power. Note that this reduction in the need to concentrate sunlight can significantly reduce the cost of a CSP system.

### Using Silicon as a Selective Absorber

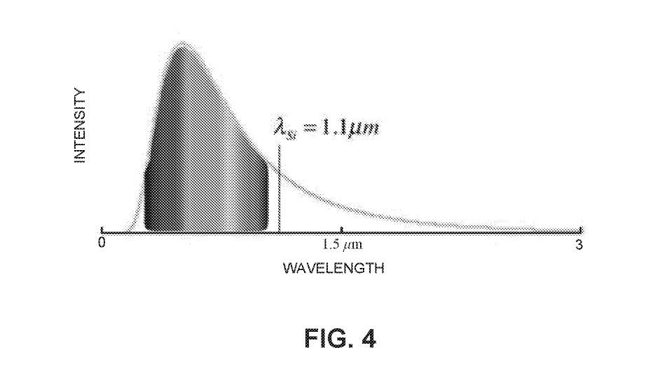

There exist a number of reasons why intrinsic silicon provides a promising candidate material for selective absorbers. First, silicon is the second-most abundant element on the surface of the earth, so scarcity of silicon is not an issue. Moreover, since the advent of silicon transistors in the 1950's, silicon manufacturing technologies have fully matured, which translates into cost savings for purchasing bulk silicon. Most importantly though, silicon's moderate band gap at 1.12 eV absorbs most visible solar radiation as is illustrated by the graph that appears in FIG. 4.

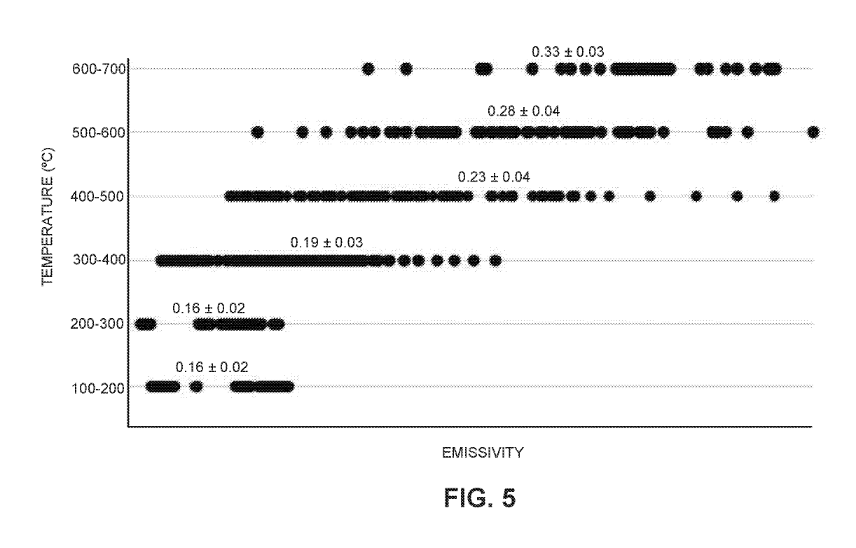

Referring to the empirical data points presented in FIG. 5, while intrinsic silicon is near room temperature, it has a small emissivity of ˜0.16 this is consistent with doped silicon experiments. However, unlike doped silicon, at elevated temperatures from 600-700° C., the emissivity values for intrinsic silicon remain low at ˜0.33. This is most likely due to no carrier contributions from doping. Note that free carriers lead to an increase in absorption and emission. The modest increase in emissivity from 0.16 to 0.33 likely corresponds to an increase in carrier concentration.

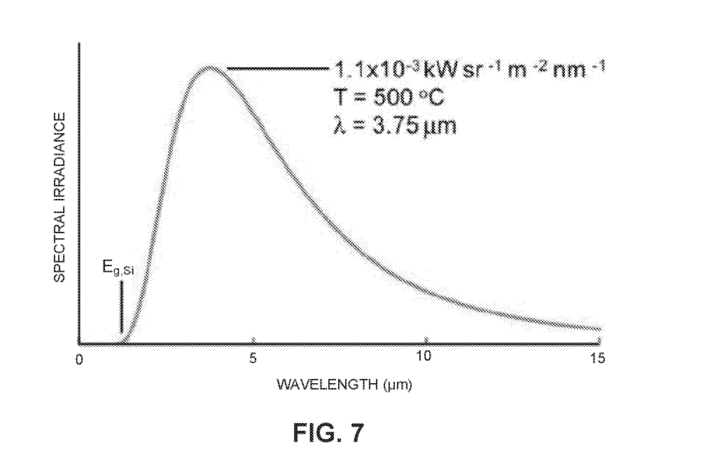

A silicon selective absorber heated to 500° C. will have peak emission at 3.75 μm as is illustrated in FIG. 7. Note that as temperature decreases, the spectral intensity decreases exponentially and the peak wavelength increases. Also note that the band gap transition for silicon occurs at 1.12 eV or 1.1 μm. Hence, silicon will have a low emissivity at moderate temperatures, which makes intrinsic silicon a promising candidate material for a selective absorber in order to harvest heat energy from sunlight.

Process of Converting Sunlight into Electricity Using a Selective Absorber

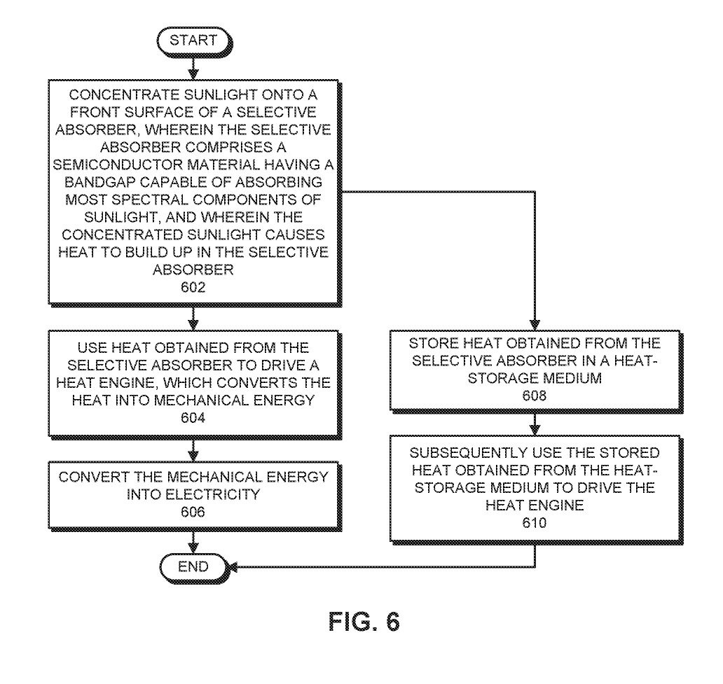

FIG. 6 presents a flow chart illustrating operations performed while converting sunlight into electricity in accordance with the disclosed embodiments. First, the system concentrates the sunlight onto a front surface of a selective absorber, wherein the selective absorber comprises a semiconductor material having a band gap capable of absorbing most spectral components of the sunlight, and wherein the concentrated sunlight causes heat to build up in the selective absorber (step 602). Next, the system uses heat obtained from the selective absorber to drive a heat engine, which converts the heat into mechanical energy (step 604). Finally, the system converts the mechanical energy into electricity (step 606). Note that the system can also store heat obtained from the selective absorber to be used to generate electricity at a later time. As illustrated in FIG. 6, this involves using a heat-storage medium to store the heat (step 608), and subsequently using the stored heat obtained from the heat-storage medium to drive the heat engine (step 610).

### Heat Reflector

The above-described selective absorber can be optimized in a number of ways. For example, the absorption characteristics for a selective absorber can be improved by adding a heat reflector (cold mirror) to the front surface of the selective absorber to lower emissivity. This heat reflector can be fabricated using an oxide such as indium tin oxide or the more abundant fluorinated tin oxide, which both have high transparency values. During operation, this heat reflector will reflect infrared radiation back into the selective absorber, wherein the reflected and reabsorbed infrared radiation will effectively lower emissivity.

### Optimizing Thickness of the Selective Absorber

Another optimization is to reduce cost by optimizing the thickness of the selective absorber material. By analyzing a simplified version of the visible spectrum, it is possible to extrapolate to obtain the optimal thickness. This can be accomplished by using Beer's law for transmittance, which relates to the ratio of transmitted power to incident power. Note that by examining the transmittance, it is possible to determine how much material is required for greatest power absorption.

Invoking Beer's law for transmittance leads to the following equations

I=I₀e^{-αx}

T=I/I₀

T=e^{-αx}

where I is the transmitted power, I₀ is incident power, and α is the absorption coefficient.

In order to absorb all of the solar spectrum that silicon can absorb, based Beer's law (described above), a planar wafer needs to be about 200 microns thick. However, by using a silver coating on the back side of the wafer, it is possible to reduce a planar wafer to be about 100 microns thick. If the front side of the wafer is then textured to make the optical path longer than the vertical path, it is possible to make the wafer 50 microns thick. Note that unlike an opaque black body, silicon has a non-infinite absorption coefficient. This means that when silicon is thin enough, it is possible see light through it. Moreover, the absorption coefficient for infrared radiation for hot silicon is significantly less than the band-to-band coefficient for most of the solar spectrum. Therefore, making the optical path length of the silicon absorber as small as possible by using back reflectors and surface texturing will greatly reduce the emissivity for silicon at 600 C, which will significantly enhance system performance.

### Other Semiconductors

One can consider using germanium as a selective absorber because it has a small band gap energy that can absorb most of the solar spectrum. However, this strength of germanium is also a weakness. Because the band gap is so small, germanium is also a great emitter. With a band gap of E_{g}=0.66 eV, germanium's main mechanism for absorption and emission occurs at 1.9 μm. In other words, it has an excellent mechanism to emit at longer wavelengths.

See Table 1, which lists band gap energies for a number of other semiconductors.

TABLE 1

| Material | E_{g} (eV) |
|---|---|
| Si | 1.12 |
| Ge | 0.66 |
| GaAs | 1.42 |
| InP | 1.34 |

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for converting sunlight into electricity, comprising:
concentrating the sunlight onto a front surface of a selective absorber,
wherein the selective absorber comprises a semiconductor material having a band gap capable of absorbing most spectral components of the sunlight, and
wherein the concentrated sunlight causes heat to build up in the selective absorber;
using heat obtained from the selective absorber to drive a heat engine, which converts the heat into mechanical energy; and
converting the mechanical energy into electricity.

2. The method of claim 1, wherein the semiconductor material comprises intrinsic silicon.

3. The method of claim 2,
wherein a back surface of the selective absorber includes a reflective coating, and a front surface of the selective absorber is textured; and
wherein a thickness of the selective absorber is reduced to approximately 50 microns, wherein this reduced thickness is made possible by the reflective coating and the texturing.

4. The method of claim 1, wherein using the heat to drive the heat engine comprises:
using a heat-storage medium to store the heat; and
subsequently using the stored heat obtained from the heat-storage medium to drive the heat engine.

5. The method of claim 4, wherein the heat-storage medium comprises molten salt.

6. The method of claim 1, wherein the method further comprises regulating a temperature of the selective absorber to remain in a normal-operating-temperature range between 500 and 600° C.

7. The method of claim 1,
wherein the selective absorber exhibits a first high emissivity for a shorter wavelength range associated with a solar blackbody spectrum; and
wherein the selective absorber exhibits a much lower second emissivity for a longer wavelength range associated with blackbody radiation emanating from the selective absorber while the selective absorber is in a normal-operating-temperature range.

8. The method of claim 1, wherein the front surface of the selective absorber includes a heat-reflecting layer, which reflects incoming infrared radiation back into space, and reflects infrared radiation from the selective absorber back into the selective absorber, thereby lowering a total system emissivity for infrared wavelengths.

9. The method of claim 1, wherein concentrating the sunlight onto the front surface of a selective absorber comprises using one or more of the following mechanisms to concentrate the sunlight:
a parabolic trough reflector;
a solar tower system comprising an array of movable mirrors that focus the sunlight on a collector tower;
a parabolic dish reflector;
a linear Fresnel lens; and
a circular Fresnel lens.

10. The method of claim 1, wherein the heat engine comprises a Stirling engine.

11. The method of claim 1, wherein converting the mechanical energy into electricity involves using an electric generator.

12. A system that converts sunlight into electricity, comprising:
a light concentrator that concentrates the sunlight to form concentrated sunlight;
a selective absorber having a front surface that is oriented to receive the concentrated sunlight,
wherein the selective absorber comprises a semiconductor material having a band gap capable of absorbing most spectral components of the sunlight, and
wherein the concentrated sunlight causes heat to build up in the selective absorber;
a heat engine that converts heat obtained from the selective absorber into mechanical energy; and
an electric generator that converts the mechanical energy into electricity.

13. The system of claim 12, wherein the semiconductor material comprises intrinsic silicon.

14. The system of claim 13,
wherein a back surface of the selective absorber includes a reflective coating, and a front surface of the selective absorber is textured; and
wherein a thickness of the selective absorber is reduced to approximately 50 microns, wherein this reduced thickness is made possible by the reflective coating and the texturing.

15. The system of claim 12, wherein the system further comprises a heat storage mechanism that:
uses a heat-storage medium to store heat obtained from the selective absorber; and
subsequently uses the stored heat obtained from the heat-storage medium to drive the heat engine.

16. The system of claim 15, wherein the heat-storage medium comprises molten salt.

17. The system of claim 12, wherein the system further comprises a regulator, which regulates a temperature of the selective absorber to remain in a normal-operating-temperature range between 500 and 600° C.

18. The system of claim 12,
wherein the selective absorber exhibits a first high emissivity for a shorter wavelength range associated with a solar blackbody spectrum; and
wherein the selective absorber exhibits a much lower second emissivity for a longer wavelength range associated with blackbody radiation emanating from the selective absorber while the selective absorber is in a normal-operating-temperature range.

19. The system of claim 12, wherein the front surface of the selective absorber includes a heat-reflecting layer, which reflects incoming infrared radiation back into space, and reflects infrared radiation from the selective absorber back into the selective absorber, thereby lowering a total system emissivity for infrared wavelengths.

20. The system of claim 12, wherein the light concentrator comprises one or more of the following mechanisms to concentrate the sunlight:
a parabolic trough reflector;
a solar tower system comprising an array of movable mirrors that focus the sunlight on a collector tower;
a parabolic dish reflector;
a linear Fresnel lens; and
a circular Fresnel lens.

21. The system of claim 12, wherein the heat engine comprises a Stirling engine.

22. A system that converts sunlight into electricity, comprising:
a light concentrator that concentrates the sunlight to form concentrated sunlight;
a selective absorber having a front surface that is oriented to receive the concentrated sunlight,
wherein the concentrated sunlight causes heat to build up in the selective absorber;
wherein the selective absorber exhibits a first emissivity for a wavelength range associated with a solar blackbody spectrum, and
wherein the selective absorber exhibits a much lower second emissivity for a longer wavelength range associated with blackbody radiation emanating from the selective absorber while the selective absorber is in a normal-operating-temperature range;
a heat engine that converts heat obtained from the selective absorber into mechanical energy; and
an electric generator that converts the mechanical energy into electricity.

23. The system of claim 22, wherein the selective absorber comprises a semiconductor material having a band gap capable of absorbing most spectral components of the sunlight.

24. The system of claim 23, wherein the semiconductor material comprises intrinsic silicon.

25. The system of claim 23,
wherein a back surface of the selective absorber includes a reflective coating, and a front surface of the selective absorber includes is textured; and
wherein a thickness of the selective absorber is reduced to approximately 50 microns, wherein this reduced thickness is made possible by the reflective coating and the texturing.

26. The system of claim 22, wherein the system further comprises a heat storage mechanism that:
uses a heat-storage medium to store heat obtained from the selective absorber; and
subsequently uses the stored heat obtained from the heat-storage medium to drive the heat engine.

27. The system of claim 26, wherein the heat-storage medium comprises molten salt.

28. The system of claim 22, wherein the system further comprises a regulator, which regulates a temperature of the selective absorber to remain in a normal-operating-temperature range between 500 and 600° C.

29. The system of claim 22, wherein the front surface of the selective absorber includes a heat-reflecting layer, which reflects incoming infrared radiation back into space, and reflects infrared radiation from the selective absorber back into the selective absorber, thereby lowering a total system emissivity for infrared wavelengths.

30. The system of claim 22, wherein the light concentrator comprises one or more of the following mechanisms to concentrate the sunlight:
a parabolic trough reflector;
a solar tower system comprising an array of movable mirrors that focus the sunlight on a collector tower;
a parabolic dish reflector;
a linear Fresnel lens; and
a circular Fresnel lens.

31. The system of claim 22, wherein the heat engine comprises a Stirling engine.
